(19) United States
(12) Patent Application Publication
(10) Pub. No.: US 2005/0109690 A1
(43) Pub. Date: May 26, 2005

(54) System and method for purifying water with human power

(76) Inventor: Robert M. Bechtold, Webster, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 10/996,002

(22) Filed: Nov. 23, 2004

Related U.S. Application Data
(60) Provisional application No. 60/525,204, filed on Nov. 26, 2003.

(51) Int. Cl. C02F 1/00

(52) U.S. Cl. 210/239

(57) ABSTRACT

An ultraviolet water disinfection system in which the power source to operate the system is human motion. The human power source is any form of repetitive motion such as pedaling, stepping, cranking, winding, shaking, etc. This repetitive motion is converted to electrical energy of sufficient magnitude to power a small water disinfection system using ultraviolet irradiation principles.

### CROSS-REFERENCE TO RELATED PATENT APPLICATIONS

This application claims the benefit of the filing date of U.S. Provisional patent application Serial No. U.S. Ser. No. 60/525,204 filed on Nov. 26, 2003.

This invention relates generally to systems that purify water, and more particularly to a system and method for purifying water by converting human power to electrical power and ultimately to ultraviolet radiation.

### BACKGROUND OF THE INVENTION

1. Field of the Invention

The present invention relates to human powered water purification systems, and more specifically, to human powered ultraviolet water purification systems that are portable and can be powered using a range of human motion to generate electricity.

Dirty, contaminated water, or the lack of potable water, is a major source of disease and infant mortality in countries lacking the electric power and infrastructure necessary to provide clean, drinkable water. Open water sources such as streams, rivers, ponds and lakes frequently contain Giardia and other cysts, parasites, fungi, algae, coliform and other bacteria, as well as suspended particles and sediment. These microorganisms are a major cause of illness and death in certain countries that lack an infrastructure to support safe drinking water.

The ability to purify and disinfect drinking water is typically performed with either chemicals such as chlorination, precise microfiltration, reverse osmosis filtration, or ultraviolet radiation exposure.

It is well known that a specific wavelength of ultraviolet light, known as UV-C (240-280 nm.), destroys the Deoxyribonucleic Acid (DNA) structure of many micro-organisms and bacteria, and effectively kills these micro-organisms and bacteria. This effect proves very useful for the disinfection of drinking water and other liquids.

Ultraviolet light has been effectively used to purify drinking water and other beverages such as apple cider that may contain harmful micro-organisms. In order to kill the micro-organisms present in the liquid, a specific quantity of ultraviolet radiation must be administered to the liquid volume by controlling the intensity of the ultraviolet light, and the volume treated per unit of time.

2. Description of the Prior Art

The prior art has disclosed various techniques for treating water with ultraviolet irradiation. Reference may be had, e.g., to U.S. Pat. No. 1,473,095 to Henri et al that discloses an apparatus for sterilizing liquids by means of ultraviolet rays. This method of treatment does not, however, address the need for a self-contained human powered water purification system.

The technique of ultraviolet sterilization of drinking water has been heretofore mainly applied to dedicated water supply systems. There have been some inventions related to portable ultraviolet sterilization, such as U.S. Pat. No. 4,755,292 to Merriam, that use batteries for a portable power source. An indirect battery powered ultraviolet sterilization system is disclosed in U.S. Pat. No. 6,299,770 to Diener et al, that uses power from an automotive source such as a cigarette lighter.

In certain regions of the world without available electric power, the use of an electrically powered ultraviolet purification system has been impractical. The use of batteries to power an ultraviolet purification system is also impractical because of the power requirements of the ultraviolet light source, the lack of readily available replacement batteries, and the environmental issues associated with proper battery disposal. In these regions, the use of human power to accomplish a beneficial result is a very accepted and readily available alternative. The use of human power provides the most economical, readily available means to purify water in many parts of the world. It is anticipated that this invention will reduce water borne diseases in drinking water, and improve the health and well being of humanity in many regions of the world.

It is an object of the present invention to provide for quick, easy, and low cost disinfection of water or other liquid without reliance on an external power source or batteries.

### BRIEF SUMMARY OF THE INVENTION

In accordance with the present invention, there is provided a human powered water purification system comprising a source of ultraviolet radiation, a liquid retaining vessel in optical communication with said source of ultraviolet radiation, and a human powered electrical generator for providing electrical power to said source of ultraviolet radiation. The electric generator is human powered, using repetitive motions that may include pedaling, cranking, winding, stepping, running, swinging, shaking.

The liquid retaining vessel may take on several shapes; for example, a bucket, a coiled tube, or a straight tube.

The human powered water purification system may contain an ultraviolet light sensor in communication with said source of ultraviolet radiation. One embodiment of the invention may include reflective means to direct the ultraviolet radiation. Another embodiment of the invention may include a second liquid retaining vessel. Another embodiment of the invention may include a control circuit assembly for regulating the source of ultraviolet radiation. Another embodiment of the invention may include a mechanical filter. Other embodiments of the invention may include a safety interlock to prevent untreated water from being used. Another embodiment of the invention may include an electrical energy storage device such as a battery or a capacitive element.

The invention uses simple human power to provide clean drinking water in a short period of time. The use of human power eliminates the need for connection to a power grid or fossil fuel powered generator, and further eliminates the need for batteries that are costly, require periodic replacement, and are detrimental to the environment. This invention also provides for a continuous source of clean drinking water without the possibility of being without a replacement battery or a connection to an external power source that may not be available. It is anticipated that this invention will reduce the transmission of water borne diseases in various regions of the world, and be beneficial to the overall health of given populations. Therefore, a further object of the present invention is a method of purifying water with human power comprising the steps of generating electrical energy using human power, using the electrical energy to power a source of ultraviolet radiation, and exposing a volume of water to said source of ultraviolet radiation.

### BRIEF DESCRIPTION OF THE DRAWINGS

The invention will be described by reference to the following drawings, in which like numerals refer to like elements, and in which:

FIG. 1 is a perspective view of one embodiment of a human powered water purification system that is partially broken away to show the ultraviolet light source and in which the raw water and the water treatment vessel are the same;

FIG. 2 is a perspective view of another embodiment of a human powered water purification system that is partially broken away to show the ultraviolet light source and in which the raw water is purified by passing through a clear, coiled tube in close proximity to an Ultraviolet light source;

FIG. 3 is a perspective view of another embodiment of a human powered water purification system that is partially broken away to show the ultraviolet light source and in which the raw water is purified by passing through a series of one or more parallel clear tubes in close proximity to an Ultraviolet light source;

FIG. 4 is an electrical 1-line diagram of one embodiment of a human powered water purification system;

FIG. 5 is a perspective view of one embodiment of a human powered water purification system.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements.

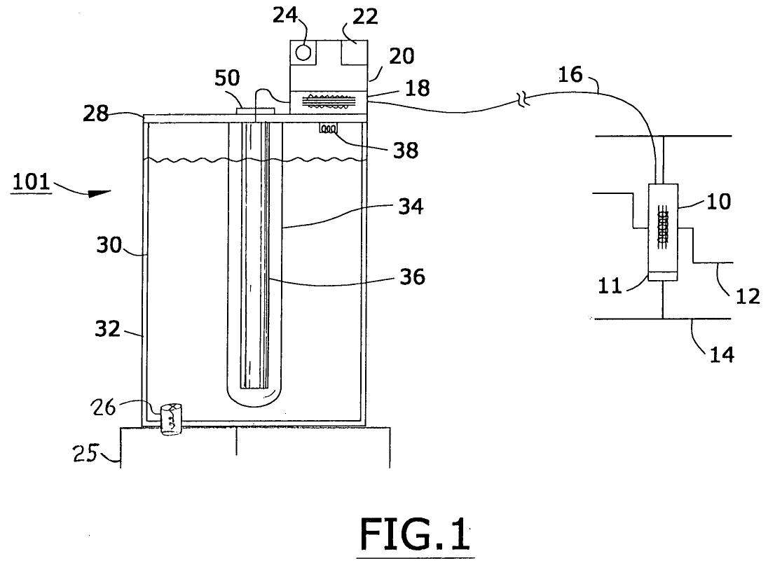

Referring to FIGS. 1-3, there are three embodiments of the present invention that all contain the same basic elements, but differ in the manner in which liquid is exposed to ultraviolet light. These preferred embodiments are not meant to be limiting. Each embodiment contains the basic elements of a human power source in combination with an electric generator, an ultraviolet light assembly with associated control circuitry, and a vessel or conduit to contain and pass liquid through the ultraviolet light.

Referring now to FIG. 1, and to the preferred embodiment depicted therein, there is shown a human powered water purification system 101. In the embodiment depicted, the water purification system 101 contains a source of ultraviolet radiation, such as a tubular ultraviolet lamp 36. The ultraviolet lamp 36 may be contained in a protective housing 34 that, in one embodiment, is manufactured from quartz, glass, ultraviolet resistant plastic, or similar material that provides protection, insulation, and perviousness to ultraviolet light.

In one embodiment, the ultraviolet lamp 36 may be removed from this protective housing 34 through an access port 50.

The ultraviolet lamp 36 is electrically connected to a transformer 18 to provide the appropriate voltage level to power the ultraviolet lamp 36. The ultraviolet lamp 36 may be semiconductor based, which may eliminate the need for a transformer 18. In one embodiment, the power source for the transformer 18 comprises an electric generator 10 that is powered by human action. The electric generator 10 may contain gearing to increase the rotation of the electric generator 10. The human action may consist of pedaling, cranking, winding, stepping, running, shaking, swinging, jumping, walking, or other repetitive motion necessary to power a small electric generator. The generator is preferably contained in a mechanical stand 14 that in one embodiment also contains the appropriate human interface device 12 such as a pedal or crank. In one embodiment, the transformer 18 for the ultraviolet lamp 36 is connected to the generator 10 by a cable 16 of sufficient gauge, mechanical strength, and length to meet the specific operating environment. Additionally, the generator may contain an optional energy storage device 11 such as a capacitive element or a battery that provides for the storage of a quantity of charge to allow for a temporary interruption in human action without the necessity of repeating the sterilization cycle.

In one embodiment, the ultraviolet lamp assembly 36 is contained in a protective sleeve 34, and mechanically mounted to a sealing bucket lid 28. The bucket lid also may provide a mounting platform for additional components necessary for the ultraviolet purification system. In one embodiment, the transformer 18 may be mounted to the bucket lid 28. Additionally, a control circuit assembly 20 may be mounted to the bucket lid. The control circuit assembly 20 provides timing and failsafe functionality to the ultraviolet purification system. This functionality may include a continuity check to ensure that the bulb is operating, a safety interlock 26 to prevent the water from being dispensed before it is completely disinfected, a sensing function to ensure that the proper ultraviolet exposure levels are met, a visual alarm 24 to indicate a system malfunction, and a timer to control the ultraviolet exposure time. In one embodiment, the control circuit assembly 20 may include an hour meter 22 to inform the operator of the need to change the ultraviolet bulb.

In one embodiment, the bucket 32 also contains a safety interlock 26 that prevents the dispensing of liquid before it is thoroughly disinfected. In addition, in another embodiment, an ultraviolet light sensor 38 such as a cadmium sulfide cell may be used to provide assurance to the control circuit assembly 20 that the ultraviolet radiation is of sufficient intensity for proper disinfection.

In one embodiment, the assembly that contains the bucket lid 28, the control circuit assembly 20, the transformer 18 and ultraviolet lamp 36 is placed on top of a bucket 32 that may be lined with an ultraviolet reflective means 30 such as stainless steel, reflective mylar, aluminum or the like. The reflective means 30 increases the effectiveness of the ultraviolet radiation in killing water borne microorganisms and bacteria. In one embodiment, once the bucket lid 28 is placed on top of the bucket 32, water cannot be dispensed due to the safety intelock 26 until the treatment process is determined to be complete by the control circuit assembly 20. In one embodiment, the bucket 32 rests on a stand 25.

In another embodiment, the control circuit assembly 20 may be placed in the mechanical stand 14. In a further embodiment, the transformer 18 is placed in the mechanical stand 14. In another embodiment, the energy storage device 11 is placed in the mechanical stand 14.

In operation of the present invention, preferably pre-filtered water is poured into the bucket 32 up to a certain level that may be indicated by a mark on said bucket 32. The bucket lid assembly is then placed on top of the bucket, and sealed by screwing down, clamping or latching. A person then begins the mechanical motion necessary to generate the electricity needed for disinfection. This is accomplished by pedaling, cranking, stepping or other repetitive motion using the human powered electric generator 10. In one embodiment, once sufficient power is sensed by the control circuit assembly 20, a timer will start, and continue until such time as the water is properly disinfected. Once the water is properly disinfected (usually on the order of several minutes), the operator will be provided with a signal indicating that the water may be safely dispensed. The signal may be visual, audible, or a combination thereof. Should a safety interlock 26 be used to regulate the dispensing of water, the safety interlock 26 will open in conjunction with the signal which indicates that the water may be safely dispensed.

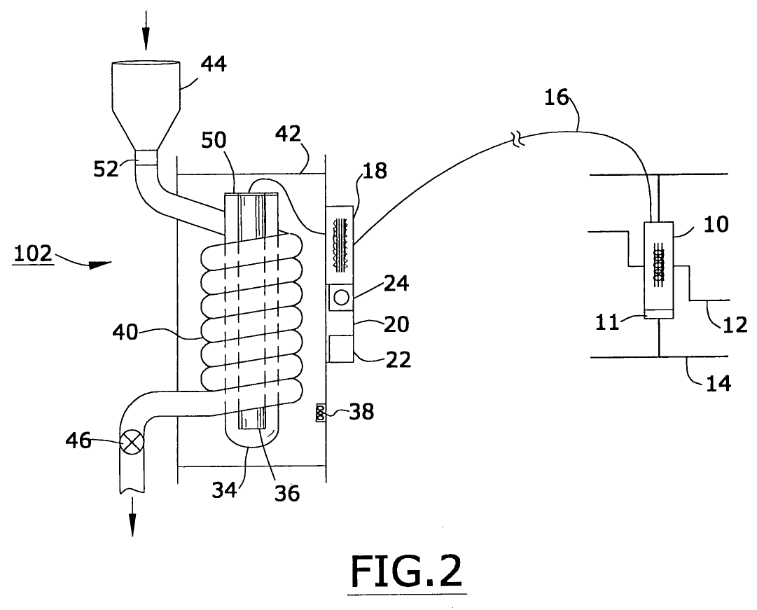

Referring now to FIG. 2, and to the preferred embodiment depicted therein, there is shown a human powered water purification system 102. In the embodiment depicted, the water purification system contains a source of ultraviolet radiation, such as a tubular ultraviolet lamp 36. The ultraviolet lamp 36 may be contained in a protective housing 34 that, in one embodiment, is manufactured from quartz, glass, ultraviolet resistant plastic, or similar material that provides protection, insulation, and perviousness to ultraviolet light.

In one embodiment, the ultraviolet lamp 36 may be removed from this protective housing through an access port 50.

The ultraviolet lamp 36 is electrically connected to a transformer 18 to provide the appropriate voltage level to power the ultraviolet lamp 36. The ultraviolet lamp 36 may be semiconductor based, which may eliminate the need for the transformer 18. In one embodiment, the power source for the transformer 18 comprises an electric generator 10 that is powered by human action. The electric generator 10 may contain gearing to increase the rotation of the electric generator 10. The human action may consist of pedaling, cranking, winding, stepping, running, shaking, swinging, jumping, walking, or other repetitive motion necessary to turn a small electric generator. The generator is preferably contained in a mechanical stand 14 that in one embodiment also contains the appropriate human interface device 12 such as a pedal or crank. In one embodiment, the transformer for the ultraviolet lamp 18 is connected to the generator 10 by a cable 16 of sufficient gauge, mechanical strength, and length to meet the specific operating environment. Additionally, the generator may contain an optional energy storage device 11 such as a capacitive element or a battery that provides for the storage of a quantity of charge to allow for a temporary interruption in human action without the necessity of repeating the sterilization cycle.

In one embodiment, the ultraviolet lamp assembly 36 is contained in a protective sleeve 34, and surrounded by a clear, ultraviolet light pervious coiled tube 40. In one embodiment, the ultraviolet lamp assembly 36 and the coiled tube 40 are mechanically held rigid by a structural frame 42. In addition, the transformer 18 may be mounted to this structural frame. Additionally, a control circuit assembly 20 may be likewise mounted to the structural frame 42. The control circuit assembly 20 provides timing and failsafe functionality to the ultraviolet purification system. In one embodiment, this functionality may include a continuity check to ensure that the bulb is operating, a safety interlock 46 to prevent the water from being dispensed before it is completely disinfected, a sensing function to ensure that the proper ultraviolet radiation exposure levels are met, a visual alarm 24 to indicate a system malfunction, a timer to control the ultraviolet light exposure time. In one embodiment, the control circuit assembly 20 may include an hour meter 22 to inform the operator of the need to change the ultraviolet bulb.

In another embodiment, the control circuit assembly 20 may be placed in the mechanical stand 14. In a further embodiment, the transformer 18 is placed in the mechanical stand 14. In another embodiment, the energy storage device 11 is placed in the mechanical stand 14.

In one embodiment, an ultraviolet light sensor 38 such as a cadmium sulfide cell may be used to provide assurance to the control circuit assembly 20 that the ultraviolet radiation is sufficient for disinfection.

In one embodiment, this structural frame 42 also provides a mounting point for a raw water intake 44 that is fluidly connected to the coiled tube 40. The raw water intake 44 may, in one embodiment, also contain a mechanical filter 52 that is useful for removing larger particles that may be present in the water. Removal of these particles is important for complete disinfection, as the larger particles tend to cause “shadowing” of the ultraviolet light, and decrease the effectiveness of the sterilization process.

In operation of the present invention, raw water is poured into the raw water intake 44. A person then begins the mechanical motion necessary to generate the electricity needed for disinfection. This is accomplished by pedaling, cranking, stepping or other repetitive motion using the human powered generator 10. Once sufficient power is sensed by the control circuit assembly 20, a timer will start, and continue until such time as the water is properly disinfected. Once the water is properly disinfected (usually on the order of several minutes), the operator may be provided with a signal indicating that the water may be dispensed. The signal may be visual, audible, or a combination thereof. Should a safety interlock 46 be used to regulate the dispensing of water, the safety interlock 46 will open in conjunction with the signal which indicates that the water has been properly disinfected.

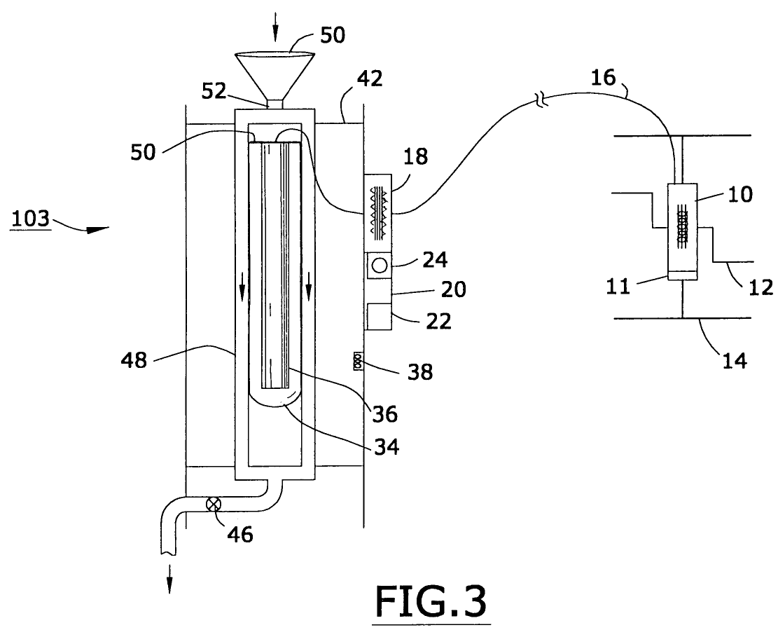

Referring now to FIG. 3, and to the preferred embodiment depicted therein, there is shown a human powered water purification system 103. As shown, the water purification system contains a source of ultraviolet radiation, such as a tubular ultraviolet lamp 36. The ultraviolet lamp 36 may be contained in a protective housing 34 that, in one embodiment, is manufactured from quartz, glass, ultraviolet light resistant plastic, or similar material that provides protection, insulation, and perviousness to ultraviolet light.

In one embodiment, the ultraviolet lamp 36 may be removed from this protective housing through an access port 50.

The ultraviolet lamp is electrically connected to a transformer 18 to provide the appropriate voltage level to power the ultraviolet lamp 36. The ultraviolet lamp 36 may be semiconductor based, which may eliminate the need for a transformer 18. In one embodiment, the power source for the transformer 18 comprises an electric generator 10 that is powered by human action. The electric generator 10 may contain gearing to increase the rotation of the electric generator 10. The human action may consist of pedaling, cranking, winding, stepping, running, shaking, swinging, jumping, walking, or other repetitive motion necessary to turn a small electric generator. The generator is preferably contained in a mechanical stand 14 that in one embodiment also contains the appropriate human interface device 12 such as a pedal or crank. In one embodiment, the transformer for the ultraviolet lamp 18 is connected to the generator 10 by a cable 16 of sufficient gauge, mechanical strength, and length to meet the specific operating environment. Additionally, the generator may contain an optional energy storage device 11 such as a capacitive element or a battery that provides for the storage of a quantity of charge to allow for a temporary interruption in human action without the necessity of repeating the sterilization cycle.

In one embodiment, the ultraviolet lamp assembly 36 is contained in a protective sleeve 34, and surrounded by a plurality of clear, ultraviolet light pervious parallel tubes 48. In one embodiment, the ultraviolet lamp assembly and the parallel tubes 48 are mechanically held in place by a structural frame 42. In addition, the transformer 18 may be mounted to this structural frame. Additionally, a control circuit assembly 20 may be mounted to the structural frame 42. The control circuit assembly 20 provides timing and failsafe functionality to the ultraviolet purification system. In one embodiment, this functionality may include a continuity check to ensure that the bulb is operating, a safety interlock 46 to prevent the water from being dispensed before it is completely disinfected, a sensing function to ensure that the proper ultraviolet light exposure levels are met, a visual alarm 24 to indicate a system malfunction, a timer to control the ultraviolet light exposure time. In one embodiment, the control circuit assembly 20 may include a simple hour meter 22 to inform the operator of the need to change the ultraviolet bulb.

In another embodiment, the control circuit assembly 20 may be placed in the mechanical stand 14. In a further embodiment, the transformer 18 is placed in the mechanical stand 14. In another embodiment, the energy storage device 11 is placed in the mechanical stand 14.

In one embodiment, an ultraviolet light sensor 38 such as a cadmium sulfide cell may be used to provide assurance to the control circuit 20 that the ultraviolet radiation is of sufficient intensity for disinfection.

In one embodiment, the structural frame 42 also provides a mounting point for a raw water intake 50 that is fluidly connected to the parallel tubes 48. The raw water intake 50 may, in one embodiment, contain a mechanical filter 52 that is useful for removing larger particles that may be present in the water. Removal of these particles is important for complete disinfection, as the larger particles tend to cause “shadowing” of the ultraviolet light, and decrease the effectiveness of the sterilization process.

In operation of the present invention, raw water is poured into the raw water intake 50. A person then begins the mechanical motion necessary to generate the electricity needed for disinfection. This is accomplished by pedaling, cranking, stepping or other repetitive motion using the human powered generator 10. Once sufficient power is sensed by the control circuit assembly 20, a timer will start, and continue until such time as the water is properly disinfected. Once the water is properly disinfected (usually on the order of several minutes), the operator may be provided with a signal indicating that the water may be dispensed. The signal may be visual, audible, or a combination thereof. Should a safety interlock 46 be used to regulate the dispensing of water, the safety interlock 46 will open in conjunction with the signal that indicates that the water has been properly disinfected.

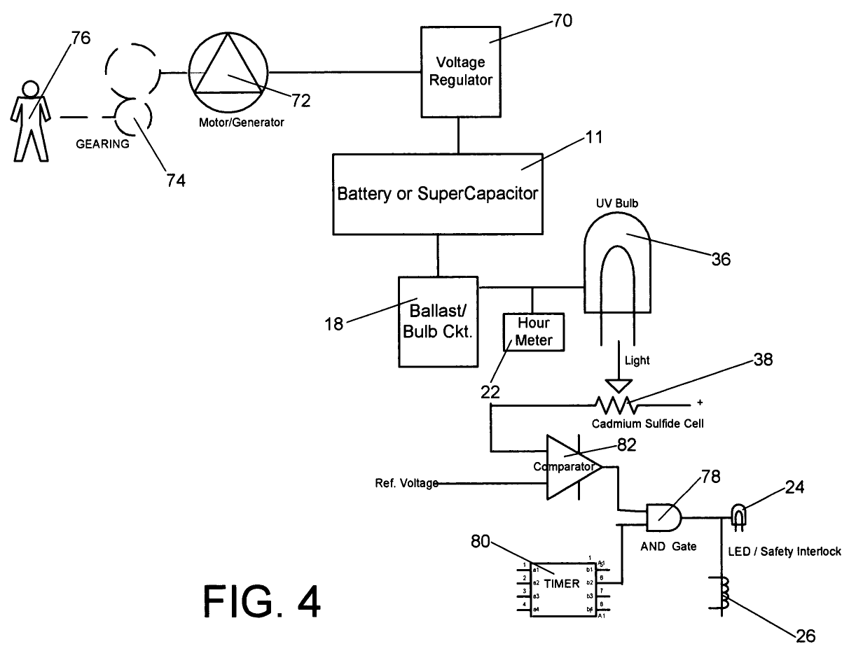

FIG. 4 depicts an electrical one line diagram of a preferred embodiment of the invention. Various components may be omitted or substituted as may be known and understood by one skilled in the art. In FIG. 4, a motor/generator 72, such as a permanent magnet motor/generator is mechanically connected to a gear mechanism 74. The gear mechanism 74 serves to increase the rotational speed of the motor generator 72. The gear mechanism 74 is rotated by a human 76 using a human interface such as pedals or cranks (not shown). The motor/generator 72 is electrically connected to a voltage regulator 70 to smooth and regulate the power provided by the rotating motor/generator 72. The voltage regulator 70 may optionally be connected to an energy storage device 11 such as a battery or a capacitive element such as a super capacitor. The voltage regulator 70 may be directly connected, or connected by way of the energy storage device 11, to a transformer 18 that serves as a ballast/bulb circuit to power an ultraviolet light source 36. The use of a semiconductor ultraviolet light source such as a light emitting diode may eliminate the need for said transformer 18. An hour meter 22 may optionally be connected to the ultraviolet light source 36. An ultraviolet light sensor 38 may optionally be optically coupled to the ultraviolet light source 36 to provide an indication that the ultraviolet light source is providing germicidal radiation. A timer 80, such as a 555 integrated circuit timer, may be used to time ultraviolet radiation exposure duration, and provide a visual or audible indication that a minimum exposure duration has been met for adequate disinfection of water. The timer 80 may also control a safety interlock 26, allowing for the dispensing of water only after a specified exposure duration has been met. The timer 80 may also control a visual indicator 24 such as a light emitting diode, where the visual indicator 24 alerts the operator of the human powered water purifier that a minimum exposure duration has been met for adequate disinfection of water. A logic device 78 such as an AND gate may optionally be used to provide assurance that both the ultraviolet light source 36 is providing germicidal radiation and that a minimum exposure duration has been met for adequate disinfection of water. Upon satisfaction of both assurance criteria, a visual indicator 24 is illuminated, and optionally a safety interlock 26 is released.

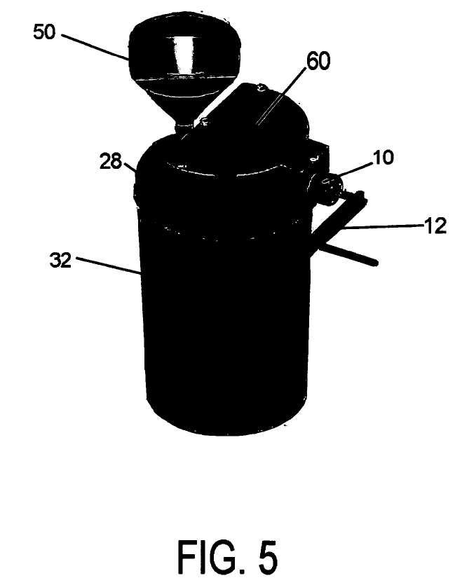

Referring lastly to FIG. 5, a perspective view of one embodiment of a human powered water purification system is shown. In the embodiment shown, the electric generator 10 is mechanically coupled to a human interface 12 such as cranks or pedals. The housing 60 contains the control circuit assembly 20, the transformer 18, as well as access to the ultraviolet lamp 36. The housing 60 is mounted to the bucket lid 28. The bucket 32 contains water that requires purification. A funnel 50 may optionally be used to add water to the bucket 32.

In operation of the present invention, preferably pre-filtered water is poured into the bucket 32 up to a certain level that may be indicated by a mark on said bucket 32. The water is placed in the bucket either by removing the bucket lid 28 or using an optional funnel 50. A person then begins the mechanical motion necessary to generate the electricity needed for disinfection. This is accomplished by pedaling, cranking, stepping or other repetitive motion using the human powered electric generator 10 mechanically coupled to the human interface 12. In one embodiment, once sufficient power is sensed by the control circuit assembly 20, a timer will start, and continue until such time as the water is properly disinfected. Once the water is properly disinfected (usually on the order of several minutes), the operator will be provided with a signal indicating that the water may be safely dispensed. The signal may be visual, audible, or a combination thereof. Should a safety interlock 26 be used to regulate the dispensing of water, the safety interlock 26 will open in conjunction with the signal which indicates that the water may be safely dispensed.

It is, therefore, apparent that there has been provided, in accordance with the various objects of the present invention, a system and method for purifying water with human power. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A human powered water purification system comprising:
a. a source of ultraviolet radiation;
b. a liquid retaining vessel in optical communication with said source of ultraviolet radiation;
c. a human powered electrical generator for providing electrical power to said source of ultraviolet radiation.

2. The human powered water purification system as recited in claim 1 further comprising an ultraviolet light sensor in communication with said source of ultraviolet radiation.

3. The human powered water purification system as recited in claim 1 further comprising a reflective means.

4. The human powered water purification system as recited in claim 1 further comprising a second liquid retaining vessel.

5. The human powered water purification system as recited in claim 1 further comprising a control circuit assembly for regulating the source of ultraviolet radiation.

6. The human powered water purification system as recited in claim 1 further comprising a mechanical filter.

7. The human powered water purification system as recited in claim 6 wherein said mechanical filter contains activated carbon.

8. The human powered water purification system as recited in claim 1 wherein the liquid retaining vessel is a bucket.

9. The human powered water purification system as recited in claim 1 wherein the liquid retaining vessel is a tube.

10. The human powered water purification system as recited in claim 1 further comprising a safety interlock.

11. The human powered water purification system as recited in claim 1 further comprising a battery to store electrical charge generated by said human powered electrical generator.

12. The human powered water purification system as recited in claim 1 further comprising a capacitive element to store electrical charge generated by said human powered electrical generator.

13. A method of purifying water with human power comprising the steps of:
a.) generating electrical energy using human power;
b.) using said electrical energy to power a source of ultraviolet radiation; and
c.) exposing a volume of water to said source of ultraviolet radiation.
